(19) United States
(12) Patent Application Publication
(10) Pub. No.: US 2003/0186812 A1
(43) Pub. Date: Oct. 2, 2003

(54) Synergistic formulation as plant growth regulator

(76) Inventors: Amitabha Chattopadhyay, Uttar Pradesh (IN); Neeru Gupta, Uttar Pradesh (IN); Mahendra Pandurang Darokar, Uttar Pradesh (IN); Suman Preet Singh Khanuja, Uttar Pradesh (IN)

Correspondence Address: POWELL, GOLDSTEIN,, FRAZER & MURPHY LLP, P.O. BOX 97223, Washington, DC, 20090-7223, US

(21) Appl. No.: 10/102,948

(22) Filed: Mar. 22, 2002

(51) Int. Cl. A01N 63/00; A01N 25/00

(52) U.S. Cl. 504/116.1

(57) ABSTRACT

The present invention relates to a mint spent compost based synergistic formulation useful as plant growth regulator comprising bioactive extracts from mint spent compost such as composted distilled crop residue of Menthol mint; Mentha arvensis etc., and nutrient mixtures exhibiting synergistic effect in enhancing plant growth also this invention provides a unique process for the preparation of the said formulation and the methods of its application.

### FIELD OF THE INVENTION

The invention relates to a mint spent compost based synergistic formulation useful as plant growth regulator, said formulation comprising bioactive extracts obtained from mint spent composted distilled crop residue of aromatic crops such as Menthol mint, Mentha arvensis etc., and nutrient mixtures, exhibiting synergistic effect in enhancing plant growth. This invention also provides a unique process for the preparation of the said formulation and the methods of its application.

### BACKGROUND OF THE INVENTION

Spent materials are the crop residues of aromatic plants, that are obtained as by-product after extraction of essential oil from fresh herb of the plant through its steam or hydro-distillation. In most of the cases these spent materials are being used as fuel in the steam generation unit. An alternative utilization of mint spent or mint marc for manufacture of strawboard, fiber board and paper pulp has been reported (Chawala, J. S. 1982). Mint spent on the other hand retain all the plant nutrients that have been taken by the crop and after being composted it could well be utilized as source of plant nutrients. Besides all these plant nutrients, composted crop residues are supposed to contain other bioactive molecules such as phyto-hormones, vitamins, humic substances etc. Humic substances are naturally found in soil and act as storehouse of the plant nutrients. Apart from well recognized contribution of humic substance in enhancing soil available nutrient status, a small fraction of low molecular weight components of humic substances are reported to increase cell membrane permeability and to exhibit hormone like activity (Vaughan and Malcom 1985). Polyamines isolated from soil and humic acids have been found to exhibit hormone like activity and increased radical growth of Lettuce (Young and Chen 1997). Isolated humic substances from soil have been shown positive influence on growth parameters and biomass of teak seedlings (Fagbenro and Agboola 1993). Humic substances isolated from composted or chemically decomposed poplar sawdust showed positive influence on mineral nutrition of ryegrass (Bidegain et al 2000). Commercial organo bio stimulant containing humic acids have also been reported to be tested for field grown bedding plants (Poincilot 1994).

So far no attempt have been made to isolate such bioactive compounds from distilled crop residues of aromatic plants (spent material) and to utilize its plant growth regulative property. Mint spent, the distillation by-product, obtained after extraction of mint oil from Menthol mint crop is at present being used as fuel and thereby enormous loss of plant nutrients (such as 26.2% carbon, 1.35% nitrogen, 0.36% phosphorus, 1.3% potassium etc. Chattophyay & Gupta 1999, JMAPS 21:1058-1063) and bioactive substances present in it is occurring. This is the first attempt to isolate bioactive substances from composted mint spent and examine its bioactivity using a unique and novel approach wherein the bioactivity (plant growth regulation) of the extracts of mint-spent compost is tested in-vitro conditions using a plant biosensor (Bacopa test) system developed at CIMAP (Khanuja et al. 2001, JEPTO 20(1) 15-22) where the said extract exhibited plant growth promoting activity. Upon obtaining the plant growth promoting activity through the in-vitro assays on plant biosensor system, we used the same extracts from composted mint spent in form a foliar spray on potted plants of Mentha arvensis and Pelargonium graveolense. The foliar spray of extracts from composted mint spent alone, however, did not exhibit the significant activity of growth promotion under the green house conditions. Therefore, the differences in the conditions for in-vitro experiments and the green house experiments were worked out. The major difference was that in the in-vitro assays the extracts had been supplied in the form of a supplement to the basal MS medium (Murashige and Skoog 1962. Physiol Planta 15:473-497) while in case of foliar spray it was just the diluted extracts. Now to find out whether the MS basal medium had contributed to the plant growth-promoting activity of the extracts in synergistic manner the foliar spray was reformulated by supplementing the nutrients present in the MS basal medium. These experiments led to the observations that the formulation consisting of extracts from composted mint spent supplemented with nutrient mixture were synergistic in its growth promoting potential even when used as foliar spray on the said plant system. Experiments were designed to carryout comparative activities of the extracts of mint-spent compost, micronutrients and their combinations ultimately leading to the claimed synergistic formulation.

### OBJECTIVE OF THE INVENTION

The main object of the present invention is to provide a synergistic formulation of aromatic spent compost useful as plant growth regulator comprising bioactive extracts from aromatic mint spent compost and nutrient mixtures.

Another object of the present invention is to provide a synergistic formulation of mint spent compost useful as plant growth regulator comprising bioactive extracts from mint spent compost and nutrient mixtures.

Another object of the present invention is to isolate bioactive extracts from composted mint spent using proper extractants.

Yet another object of the present invention is to assess the plant growth-regulating efficacy of the extracts from mint spent compost using a plant biosensor system in in-vitro conditions.

Still another objective of the present invention is to assess the efficacy of the isolated bioactive extracts alone and in combination with nutrient mixtures on plant growth.

### SUMMARY OF THE INVENTION

Accordingly the present invention provides a aromatic plant spent compost based synergistic formulation useful as plant growth regulator, said formulation comprising bioactive extract obtained from mint spent composted distilled crop residue of aromatic crops such as Menthol mint; Mentha arvensis etc., and nutrient mixtures, exhibiting synergistic effect in enhancing plant growth. This invention also provides a unique process for the preparation of the said formulation and the methods of its application.

### DETAILED DESCRIPTION OF THE INVENTION

Accordingly, the present invention provides a synergistic formulation useful as plant growth regulator, said formulation comprising a bioactive extract from aromatic plant spent compost in the range of 0.5 to 2.0%, a nutrient mixture and water as a carrier.

In an embodiment of the invention, the bioactive extract is obtained from aromatic plant compost and preferably, mint plant spent compost.

Still another embodiment of the invention, said compost consists of bioactive substances obtained from distilled mint crop residues or other aromatic plants.

Still another embodiment of the invention, the amount of bioactive active extract is in the range of 0.5 to 2.0%.

Yet another embodiment of the invention relates to the nutrient mixture, wherein the nutrient mixture is a sulphate solution consisting of Fe, Zn, Mn and Cu salts and the amount of nutrient mixture is in the range of 0.2 to 2.05%.

Yet another embodiment of the invention relates to the concentration of Fe and Zn, which is in the range of 5-10 ml/l and concentration of Mn and Cu is in the range of 2.5-5 ml/l.

Yet another embodiment of the invention provides efficacy of said formulation, which is comparable to known plant growth regulator such as Indole Butyric Acid.

Yet another embodiment of the invention, wherein the said formulation enhances shoot height, leaf numbers, leafs area, herb-yield and oil yield of the plants.

Yet another embodiment of the invention, the said formulation enhances the essential oil yield by about 40 and enhances the fresh herb yield by about 25%.

One more embodiment of the invention, wherein the said formulation is applied as foliar spray or as a supplement to basal medium on standing crop to enhance the plant growth and essential oil yield.

Still another embodiment, wherein the said formulation enhancing growth of plant in sand cultures and other medium devoid of soil.

One more embodiment of the invention provides a process for the preparation of bio active extract from aromatic plant spent compost, said process comprising the steps of:

a) collecting the spent mint from the distillation units after extracting the essential oils,

b) decomposing the spent mint of step (a) for 75-90 days maintaining 50-60% moisture level in a compost pit,

c) curing the decomposed spent mint of step (b) under shade for 7-10 days,

d) adding water to the shade dried material of step (c )in the ratio 1:2.5 to 1:5 (w/v)

e) shaking the material of step (d) thoroughly intermittently for 1 hour,

f) allowing the material of step (e) to stand for overnight, and

g) filtering the supernatant first through muslin cloth and followed by filtering through Whatman filter paper to obtain a clear extract of the spent mint compost.

Still another embodiment of the invention, wherein the bioactive extract solution obtained in step (g) has pH in the range of 6.8-7.6.

Yet, another embodiment relates to the color of the solution, which is red in color and also devoid of bad odor.

The present invention provides a synergistic formulation of mint spent compost useful as plant growth regulator and a process for its preparation. The said synergistic formulation comprises of 5-20 m/1 (0.5-2.0%) bioactive extracts from mint spent compost and 2-20 ml/l (0.2-2.0%) nutrient mixtures, wherein the bioactive extract from the composted mint spent is extracted after decomposing the mint spent for 75-90 days at 50-60% moisture in compost pit followed by its curing under shade for 7-10 days, adding water to the shade dried material in the ratio ranging from 1:2.5 to 1:5 (w/v), thoroughly shaking the material intermittently for one hour, allowing the same to stand for overnight, filtering the supernatant first through muslin cloth and then through Whatman filter paper. The extract from the composted mint spent is clear, reddish brown in color and having pH ranging from 6.8-7.6.

In an embodiment of the present invention, wherein the bioactive substances present in distilled crop residues of mint or other aromatic plant could be extracted.

In other embodiment of the present invention, the synergistic formulation could be applied as foliar spray on the standing crop.

In still other embodiment of the present invention, the synergistic formulation may be used with nutrient solution of known composition (such as Hogland solution, MS medium etc), for enhancement of growth of the plant grown in sand culture or other medium devoid of soil.

In other embodiment of the present invention, wherein, a novel approach for examining the bioactivity of extracts from mint spent compost and the process for synergistic formulation.

In yet another embodiment of the present invention, the process of isolating the bioactive extracts is not limited to composted mint spent but could also be extended to other aromatic plants.

In yet another embodiment of the present invention, wherein the strategic approach using in-vitro based plant biosensor system to provide fast and unique method to assess the bioactive efficacy of extracts from aromatic plant spent compost used in the said formulation.

The composition of the present invention is a synergistic composition exhibiting unexpected properties in the plants such as increased oil yield, herbage, shoot height, leaf area, leaf number etc. These properties are not achieved by either using bioactive extract of aromatic plant spent compost or micronutrients individually. By combining the bioactive extract of aromatic plant spent compost and micronutrients, the surprising results are achieved which is not expected using the ingredients alone.

In fact, the synergism is clearly observed using very less quantum (say 0.5 to 2.0%) of bioactive extract of aromatic plant spent compost and such change in the property cannot be envisaged by the person skilled in the art. The synergistic effect was observed after much trial.

The processing of mint spent for isolation of bioactive extract involve the following steps

1: Mint spent (The left over distilled crop residue of Menthol mint) collected from the distillation unit and get it decomposed in a compost pit for 75-90 days, while maintaining 50-60% moisture.

2: The composted mint spent is dried under shade. 3: Composted mint spent is thoroughly mixed with water (1:2.5w/v) and allowed to stand for overnight.

4: Next day, the supernatant is first pressed through muslin cloth and the filtrate is passed through Whatman filter paper no 41.

Recoveries of isolated aliquot was too low with another solvent 0.5(N) NaOH, as the material became fluffy and smell of volatile NH₃ came out and the composted mint spent got de-natured. In case of aqueous extraction, the supernatant was clear. The clear aqueous extract was reddish brown in colour having pH 7.6.

Thus it has been revealed that bioactive substances present in mint spent could be extracted with water in a ratio 1:2.5 w/v.

The next step was to find out the efficacy of the isolated bioactive extract at its different level of addition alone and in combination with nutrient mixtures on plant growth parameter in in-vitro and in-vivo conditions.

The samples were tested for their plant growth regulatory activities using the plant biosensor system. The MS basal medium supplemented with test samples was used in the assays. Measured 0.5 to 1.0 ml medium containing different concentrations of the test samples was poured into 1.5 ml graduated micro-centrifuge tubes. Twig cuttings of 2.5 cm of plant biosensor system were inoculated in 5 replicates for each treatment. The MS basal medium without any supplement served as a control. These inoculated tubes were put into a half transparent desiccator allowing air passage through sterile cotton plugs fixed on opening vent. The tubes were placed such that the medium-containing portion of the tubes where roots would be initiating is inserted in to the holes of the stand made from a thermocol sheet. These desiccators were incubated at normal ambient temperature of 25-28° C. with 14 hours light and 10 hours dark cycle. The root initiation and shoot elongation was recorded from day 2 to 14 every 24 hours.

The following examples are given by way of illustration of the present invention and should not construed to limit the scope of present invention.

### EXAMPLE 1

### Bioassay for Extracts of Mint-Spent Compost Using Plant Biosensor System

In order to find out the growth regulatory properties of the extracts of composted mint spent, twig cuttings of plant biosensor system were inoculated into MSO medium containing 10 mg/liter to 200 mg/lit of extracts of mint spent compost and the responses were recorded up to two weeks in terms of root elongation, chlorophyll loss, browning (lethality) and shoot regeneration (Table 1).

TABLE 1
Effect of extracts of mint spent compost on plant biosensor system

| | Shoot | Root | | Chloro- | |
|---|---|---|---|---|---|
| | prolifera- | elonga- | Lethality | phyll | Likely |
| Sample | tion | tion | (Browning) | loss | activity |
| Extracts of | ++ | ++ | − | − | Growth |
| mint spent | | | | | promoter |
| compost | | | | | |
| MS0 medium | + | + | − | − | |
| only (Control) | | | | | |

+ = Occurred; − = Did not occur
++ = More than control

### EXAMPLE 2

Evaluation of foliar spray of bioactive extracts alone and in combination with nutrient mixture on growth parameter of Mentha arvensis.

Test Crop—Mentha arvensis with Uniform NPK Fertilizer

Tretments—:

(1) L1 (10 ml/l) of bioactive extracts of mint spent compost

(2) L2 (20 ml/l) of bioactive extracts of mint spent compost

(3) MN (Micronutrient mixture @ 10 ml/l of Fe and Zn and 5 ml/l of Mn and Cu)

(4) L1+MN

(5) L2+MN

(6) Indole Butyric Acid @50 ml/l (for comparison)

(7) Vitamin B solution @50 ml/l (for comparison)

(8) Distilled water as control

All the treatments were applied as foliar spray at an interval of 10 days for four times.

Observation: Shoot height, Leaf number, Leaf area (6^{th} leaf) after 90 days of planting. Herb and oil yield at 110 days of planting at the time of harvest.

TABLE 2
Growth parameters of Mentha arvensis under the influence of foliar
spray of bioactive extract alone and in combination with
nutrient mixture.

| Treatments | Growth parameters | | | | |
|---|---|---|---|---|---|
| foliar | Shoot | Leaf | Leaf area | Herb yield | Oil yield |
| spray of | height (cm) | number | Cm² | gm/pot | ml/pot |
| L1 | 45.6 | 145 | 8.6 | 90.5 | 0.58 |
| L2 | 44.0 | 147 | 8.0 | 92.5 | 0.65 |
| MN | 49.6 | 157 | 8.7 | 91.0 | 0.55 |
| Indole | 56.3 | 188 | 9.2 | 103.5 | 0.60 |
| Butyric Acid | | | | | |
| Vitamin-B | 55.0 | 209 | 13.9 | 93.0 | 0.59 |
| L1 + MN | 58.1 | 229 | 17.8 | 99.8 | 0.70 |
| L2 + MN | 54.6 | 220 | 15.6 | 98.3 | 0.69 |
| Distilled | 50.6 | 143 | 8.3 | 71.5 | 0.50 |
| water | | | | | |
| LSD (0.05) | 3.1 | 11 | 1.3 | 7.5 | 0.06 |

The above results clearly revealed that there was significant increase in different growth parameters and herb and oil yield of Mentha arvensis due to combine addition of bioactive extracts from mint spent and micronutrient mixture as compared to individual addition of bioactive extract or the nutrient mixture.

### EXAMPLE 3

Evaluation of Foliar Sprays of Bioactive Extracts Alone and in Combination with Nutrient Mixture on Growth Parameter on Geranium.

Test Crop—Geranium (Pelargonium gravelonices)

Treatments:

1. L1 (5 ml/l) of bioactive extracts of mint spent compost

2. L2 (10 ml/l) of bioactive extracts of mint spent compost

3. MN (Micronutrient mixture @10 ml/l of Fe and Zn and 5 ml/l of Mn and Cu)

4. L1+MN

5. L2+MN

6. Distilled water as control

All the treatments were applied at an interval of 10 days for four times

TABLE 3
Herb and oil yield of Geranium under the influence of bio-formulation

| | Fresh herb | |
|---|---|---|
| Treatments of | yield | Oil yield |
| foliar spray of | gm/pot | ml/pot |
| L1 | 85.92 | 0.59 |
| L2 | 78.99 | 0.55 |
| MN | 88.25 | 0.62 |
| L1 + MN | 91.46 | 0.66 |
| L2 + MN | 89.76 | 0.65 |
| Distilled water | 76.74 | 0.51 |

Results of the above experiment has revealed that there was enhancing influence of the said formulation, comprising 10 ml/l of bioactive extracts and micronutrient mixture (10 ml/l of Fe and Zn and 5 ml/l of Mn and Cu) on herb and oil yield of Geranium as compared to individual application of its constituents.

Results of the experiment in example 2 and 3 above indicated that foliar spray of the said formulation have synergistic influence in enhancing the growth of the plant which was not available with its respective ingredients.

### EXAMPLE 4

Influence of Extracts of Mint Spent Compost Alone and with Nutrient Mixture on Growth Parameter of Tomato (Lycopersicum esculentum) Grown in Sand Culture

Test Crop—Tomato Grown in Sand Culture

Treatments—

1. FNS (Full nutrient Hogland solution; Agarwal & Sharma 1976) as control

2. FNS+L1 (5 ml/l) of bioactive extracts of mint spent compost

3. FNS+L2 (10 ml/l) of bioactive extracts of mint spent compost

4. FNS+L3 (15 ml/l) of bioactive extracts of mint spent compost

5. HNS (Half nutrient Hogland solution) as another control

6. HNS+L1

7. HNS+L2

8. HNS+L3

TABLE 4
Evaluation of bioactive extract alone and in combination with nutrient
mixture solution on growth parameter of Tomato at 35 after treatment

| | Shoot height | Leaf area | Fresh weight |
|---|---|---|---|
| Treatments | Cm | Cm² | gm/plant |
| FNS | 12 | 26.2 | 3.2 |
| FNS + L1 | 15 | 26.5 | 3.5 |
| FNS + L2 | 18 | 28.2 | 5.0 |
| FNS + L3 | 16 | 24.0 | 4.1 |
| HNS | 13 | 18.9 | 2.9 |
| HNS + L1 | 15 | 27.3 | 3.4 |
| HNS + L2 | 15 | 22.8 | 3.5 |
| HNS + L3 | 15 | 27.0 | 3.5 |
| LSD (0.05%) | 3 | 4.8 | 0.8 |

The experimental data has revealed the synergistic influence of the extracted bioactives from composted mint spent in combination with nutrient mixture solution in increasing the shoot height, leaf area and biomass yield of Tomato grown in sand culture medium as compared to either full or half strength Hogland nutrient solution.

The main advantages of the present invention are

1. That the growth regulative properties of the distilled crop residues of aromatic plant (Spent) could be utilized in the form of a synergistic formulation useful for enhancement of plant growth.

2. The said formulation, which is a combination of extracted bioactives from composted mint spent and nutrient mixtures could be applied as foliar spray in the standing crop for enhancement of plant growth.

3. The bioactives extracted from mint spent in combination with nutrient mixture solution could also be utilized for raising plants in sand culture medium.

4. At present, the mint spent is only being utilized as fuel in the steam generation unit and therefore we are loosing the opportunity to utilize the bioactive compounds present in it. This is a first attempt to extract bioactive substances present in the mint spent compost using mild extractant for its further utilization in the form of a synergistic bio-formulation that exhibited enhancement of plant growth.

5. The strategic approach using in-vitro based plant biosensor system and subsequent testing in-vivo that could provide fast and unique method to assess the bioactive efficacy of extracts from aromatic plant spent compost.

### REFERENCES

1. Chawala, J. S. 1982 Cultivation of aromatic plants in India. Ed. By C. K. Atal. R. R. L. Jammu(C.S.I.R) Published by C.S.I.R, New Delhi.

2. Vaughan D and Malcolm R. E. 1985, Influence of humic substances on growth and physiological process. In D. Vaughan and R. E Malcolm (Ed) Soil organic matter and biological activity. Martinous Nighoff, Dordrecht. 37-75.

3. Young, C. C and Chen, L. F. 1997, Polyamines in humic acid and their effect on radical growth of Lettuce seedlings, Pl and Soil. 195:144-149.

4. Fagbemo, J. A and Agboola, A. A. 1993, Effect of different levels of humic acids on growth and nutrient uptake of teaknseedlings. Jr. Plant. Nutr. 16(8) 1465-1483.

5 R. A. Bidegain, M. Kammerer, M. Goiresse, M. Hafid, F. Rey, 2000. Effect of humic Substances from composted or chemically decomposed poplar saw dust on mineral nutrition of rye grass. Jr. Agric. Sci(Cambridge) 134(30) 259-267.

6. Poincelot, R. P. 1994 The use of commercial bio-stimulant for field grown bedding plants. Jr. Herb and consumer horticulture 1(1) 95-110.

7. Khanuja S. P. S, Darokar M. P., Mishra S., Gangwar A., Shasany A. K., Kumar T. R. S., Saikia D., and Kumar S. 2001. Development of a novel plant system as biosensor for detecting environmental hazards and bioactive molecules through distinct responses. Journal of Environmental Pathology, Toxicology and Oncology 20 (1): 15-22

8. Murashige T, Skoog F. 1962. A revised medium for rapid growth and bioassay with tobacco tissue cultures. Physiol Planta 15: 473-497.

9. Chattopadhyay A, Gupta N. 1999. Integrated nutrient management in menthol mint cultivation utilizing mint residue fertilizer. Journal of Medicinal and Aromatic Plant Sciences 21: 1058-1063.

10. Agarwal S. C., Sharma P. C. 1976. Plant nutrients—their function and uptake. In Soil Fertility Theory and Practice Ed. By Kanwar J. C., ICAR Publication, New Delhi, pp 17.

1. A synergistic formulation useful as plant growth regulator, said formulation comprising a bioactive extract from aromatic plant spent compost in the range of 0.5 to 2.0%, a nutrient mixture and water as carrier.

2. The formulation as claimed in claim 1, wherein the bioactive extract is obtained from aromatic plant compost and preferably, mint plant spent compost.

3. The formulation as claimed in claim 1, wherein said compost consists of bioactive substances obtained from distilled mint crop residues or other aromatic plants.

4. The formulation as claimed in claim 1, wherein the nutrient mixture is a sulphate solution consisting of Fe, Zn, Mn and Cu salts.

5. The formulation as claimed in claim 1, wherein the amount of nutrient mixture is in the range of 0.2 to 2.05%.

6. The formulation as claimed in claim 1, wherein the concentration of Fe and Zn is in the range of 5-10 ml/l and concentration of Mn and Cu is in the range of 2.5-5 ml/l.

7. The formulation as claimed in claim 1, wherein efficacy of said formulation is comparable to known plant growth regulator such as Indole Butyric Acid.

8. The formulation as claimed in claim 1, wherein the said formulation enhances the plant growth by enhanced shoot height, leaf numbers, leafs area, herb yield and oil yield.

9. The formulation as claimed in claim 1, wherein the said formulation enhances the essential oil yield up to 40%.

10. The formulation as claimed in claim 1, wherein the said formulation enhances the fresh herb yield up to 25%.

11. The formulation as claimed in claim 1, wherein the said formulation is applied as foliar spray or as a supplement to basal medium on standing crop to enhance the plant growth and essential oil yield.

12. A synergistic formulation as claimed in claim 1, wherein said formulation is used for the enhancement of growth of plant in sand culture and other medium devoid of soil.

13. A process for the preparation of bio active extract from aromatic plant spent compost as claimed in claim 1, said process comprising steps of:
a) collecting the spent mint from the distillation units after extracting the essential oils,
b) decomposing the spent mint of step (a) for 75-90 days maintaining 50-60% moisture level in a compost pit,
c) curing the decomposed spent mint of step (b) under shade for 7-10 days,
d) adding water to the shade dried material of step (c) in the ratio 1:2.5 to 1:5 (w/v)
e) shaking the material of step (d) thoroughly intermittently for 1 hour,
f) allowing the material of step (e) to stand for overnight, and
g) filtering the supernatant first through muslin cloth and followed by filtering through Whatman filter paper to obtain a clear extract of the spent mint compost.

15. A process as claimed claim 13, wherein the bioactive extract solution obtained in step (g) has pH in the range of 6.8-7.6.

16. A process as claimed in claim 13, wherein the solution is red in color and devoid of bad odor.
